(19) United States
(12) Patent Application Publication
(10) Pub. No.: US 2006/0213112 A1
(43) Pub. Date: Sep. 28, 2006

(54) FISHING FLY AND METHOD OF MAKING FISHING FLIES

(76) Inventor: Timothy P. Caillouet, Willow, AK (US)

Correspondence Address: WALTER J, TENCZA JR., 10 STATION PLACE, SUITE 3, METUCHEN, NJ, 08840, US

(21) Appl. No.: 11/309,023

(22) Filed: Jun. 9, 2006

(51) Int. Cl. A01K 85/08

(52) U.S. Cl. 43/42.53; 43/42.25

(57) ABSTRACT

A method for constructing a fly for fishing from fly-making materials and a hook is provided. The method may include tying fly-making materials to a hook, applying heat fusible fibers to the fly-making materials or to the hook, and shaping said heat fusible fibers through a heating process to create iridescent colored body parts for the fly. The heat fusible fibers may be shaped through a heating process with a hot iron or with heated air at temperatures ranging from one hundred and forty to two hundred degrees Fahrenheit for two to ten seconds.

### FIELD OF THE INVENTION

This invention generally relates to artificial flies used in fishing, and methods of making those flies.

### BACKGROUND OF THE INVENTION

Since the dawn of time man has searched for better ways to catch fish for food, with the earliest methods likely by hand, evolving to spear, then bow, with nets used later as recorded in early literature including the Bible. Fishing with a pole, string and some sort of hook has gone on for thousands of years, as evidenced by archeological finds of carved bones, antlers, forked sticks and metal devices fashioned into forms of hooks. One early Egyptian drawing shows a man fishing in what appears to be the Nile river utilizing what appears to be five fishing flies tied to a string on a pole. Several early references in Greek literature reference fishers tying feathers to a hook. The English word angling dates back to mid centuries where an angle was put in a needle and tied to a line and used to catch fish.

In the last few decades with increased fishing pressure, many areas are limiting fishers to non baited lures, of which a fly is just one type. Also within this time frame fly fishers have adapted tying on jigs and utilizing many more synthetic tying materials into fly patterns, as these materials better resemble natural prey species preferred by sports fish, and the use of the jig eliminates a step, adding weight to the hook.

The use of hand-tied simulations of prey species on a hook, used to catch fish has been well known for centuries, and thousands of patterns exist. Each pattern is made of a variety of materials and any particular pattern may specify hair or feathers taken from specific species of animals, as well as from a specific body part of those animals.

Several strategies in the design of fishing flies have evolved. One strategy is to make the artificial fly look and react as similar to a natural prey as possible. To achieve this, feathers, hair, plastic, various types of string, beads, lead strips, and other materials are tied to the hook to simulate a specific species of worms, leeches, insects, fish, frogs, crawfish. Other creatures in the fish's natural environment are also simulated using artificial flies, shrimp, crabs and many more animals that live in or near the water.

Another strategy in preparing flies for catching fish is not to closely simulate an insect/other in their environment, but to create a garish artificial fly which stimulates the fish to strike at it, either when protecting the fish's spawning territory, or in hostile response to the approach of the artificial fly.

To create flashy colors which cause a fish to strike at it out of a protective instinct or from an aggressive instinct, various threads, strings, films, tape and tinsel are used which can be luminescent, fluorescent, neon, pearlescent, reflective, shiny or glittery. Such materials are used in various combinations to create any shape, pattern, or color desired. Achieving these simulations is time consuming and intricate work and still requires tying and a large inventory of materials.

Another problem created by traditional fly tying methods is that when a body part on the fly is a large and bulky part, the typical fly tying materials which are used to simulate this body part are such things as thread, pile, fur, feathers, etc. These materials are water absorbent and cause the body of such a fly to become heavy when it is water logged. This results in difficulty when casting, since the basis of casting in fly fishing is to cast the heavier portion of the line, rather than the fly. The fly must be very light in weight so as not to interfere with the casting of the line. A bulky fly which is soaked with water may interfere with proper casting technique.

Sometimes it is desirable that a fly sink quickly. For instance, if a person is casting upstream or into a lake, he might want his fly to sink quickly to the bottom of the river or lake to a depth at which the bigger fish are likely to see it. To facilitate this fast sinking, weights can be incorporated into the design of the fly in the form of beads of lead, bismuth, or other heavy material. Either weighted beads or weighted strips are usually tied on to the fly to add weight.

### SUMMARY OF THE INVENTION

One or more embodiments of the present invention relate to fishing flies and a method of making fishing flies which utilizes a heat fusible fiber and a heat source to form more lifelike and realistic simulations of the body parts of many various prey, or food sources of sports fish, and which allows the attachment of body parts which are transformed through heat to create iridescent hues, with or without the addition of other commonly known and utilized fly tying materials for this purpose. The heat fusible fiber or fibers can be blended with non-heat fusible polyester fibers.

One of the objects of the present invention is to provide a method of making artificial flies which allows a heat fusible fiber to be used to simulate body parts of the creature being simulated more realistically, or flashier through the use of a heat process to cause the materials to radiate an iridescence through an easier and faster process that can not currently be achieved through currently utilized materials or processes.

Another object of the present invention is to provide a method of making artificial flies in which body parts of the flies are of the desired color and shape, are light in weight, and do not absorb water.

Another object of this invention is to eliminate the need of a large inventory of fly tying materials in order to tie a wide variety of flies.

A further object of the present invention is to provide a method by which traditional fly tying materials can be changed to any desired iridescent hue, by the use of mixing and or blending the colors of the heat fusible fiber, and can be made to appear to be vertically or horizontally striped by varying how heat is applied to the heat fusible fiber.

Another object of the present invention is to provide a method of securing and disguising beads, strips or threads of material added to the fly for weight.

An additional object of the present invention is to provide a method of covering preformed corks, foam or pieces of lightweight material such as foam strips, which are added for buoyancy. Any of these can be coated in any quick drying water proof adhesive, covered with the heat fusible fiber and heated with a hot air gun to change the appearance to a shiny iridescent in any desired hue.

Still another object of the present invention is to provide a cure and heat treatment method for increased durability of the heat fusible fiber used in making flies.

One or more embodiments of the present invention provide a method for making fishing flies which utilizes heat fusible fibers and a heating process to form body parts of the fly which when heat is added changes the heat fusible fibers to an iridescent shine that more realistically resembles a natural prey, thereby triggering the natural predatory instincts of the fish to greatly increase a fisher's success.

The heat fusible fibers can be secured to the hook, or it can be applied over traditional fly-tying materials. Other materials of all commonly acceptable fly tying materials can be added with the heat fusible fibers during the construction, such as Mylar, filaments of plastic or hair which will form the tail, fins, legs, wings or other body parts of the fly. The heat fusible fibers can be formed into body parts which are remote from the body of the fly, such as tail, fins, legs, knee joints, antennae tips. Any desired color can be achieved by mixing from a selection of colored heat fusible fibers, along with iridescence through the process of heating the heat fusible fibers in varying temperatures and time. Increased buoyancy of the fly can be achieved by using buoyant materials with the water heat fusible fibers to form body parts. Through tying the heat fusible fibers and applying the heat process to a hook or weighted jig hook or adding weighted wire, cones, beads or barbells to the hook, aids in assisting the fly to sink to the fish's depth in the water structure, if this is required under certain circumstances known to anglers.

Since the heat fusible fibers do not absorb as much water as natural materials, fly casting is easier. The use of this method of tying flies with heat fusible fibers results in a greater variety of colors and body shapes, enhanced weighting or flotation characteristics, improved durability of the fly, with more realistic simulation of prey through the iridescence created by the addition of the heating process of the heat fusible fibers, which greatly increases the attack instinct of carnivorous fish species, thereby increasing the fly fishers chance of having the more realistic looking fly being accepted and taken by game fish.

These objects, along with others, are accomplished by the use of the heat fusible fiber, of the type used on fabrics, to color parts of a fly, create simulations of body parts on fishing flies and to serve as the appendages. These heat fusible fibers, which are made of shredded plastic film manufactured by Meadowbrook Inventions, Inc. under the Trade name Angelina® are intended for use in the garment industry.

The special properties of the coating on the plastic film itself causes the film to sparkle, and when the heat fusible fiber in the fly is heat treated, it transforms into an iridescent hue of the particular shade of the material, unmatched by any other current material now utilized by fly tiers. The heat treating slightly hardens the film, which melts and attaches itself to other pieces of the shredded heat fusible materials, and some materials of different chemical compounds and organic origin, such as hair and feathers.

With the use of a heat treatment step, flies made by embodiments of the present invention become much more durable, and durable enough for extended use in the water and the abuse of the sport fish's teeth.

With the use of a heat treatment step, unique appearances can be set by the appropriate heat treatment (temperature), time (length of heat treatment) and method (hot iron and/or hot air blowing combined or alone) in order to achieve different characteristics of the fly or body part, depending upon the types of materials being utilized to construct the fly and/or the body parts to be utilized in the construction of flies, along with trapping air bubbles. These trapped bubbles of air create a buoyancy effect, causing the flies to float on the surface, or at various depths, depending upon the extent of bubble formation and entrapment and if additional weighted materials are added in the construction process.

The heat fusible fiber, after blending several shades for color and sparkle, can also be attached in such a way as to cover a cork or foam shaped float, thereby eliminating several steps, namely the application of a base coat of waterproof paint, one or two coats of colored paint and the final clear coat, reducing labor costs so as not to have to outsource the production to overseas firms, as with most other flies to stay competitive in sales price.

After the heat fusible fiber is heat treated, glue on eyes can be attached (if desired for the particular fly pattern) and when the adhesive is dry the fly may be used for fishing. This method results in flies which have a different appearance than traditional flies, which may prove advantageous under certain conditions when fish are not accepting traditional flies. The method is also a means to modify traditional flies with the addition of the heat fusible fiber and heating process, or as a complete replacement for traditional flies, as fly fishers are constantly searching for “the newest fly”. Flies made using this method also can be made with either very thin or fairly bulky body parts, but which are very light in weight and do not hinder the casting of the fly fishing line. Since these body parts are not water absorbent, they do not absorb water and become heavier for casting, as traditional fly-tying materials do. Flies made in this method can have realistic appearing appendages formed through the heating process inserted and attached to the hook or layered over into the heat fusible fiber and heat treated and attached with an adhesive such as hot melt glue.

Flies made using a method in accordance with one or more embodiments of the present invention can be made with beads, strips or pieces of material anchored to the body of the fly, and disguised as crawfish, shrimp, baitfish, frog or other animal and insect body parts, in which the beads, strips or other material are added for desired look or purposes of weight or buoyancy. Foam, wood, cork or plastic shapes can be attached for buoyancy, or the heat fusible fiber can be tied on a hook, weighted with wire, bead chain, barbell eyes, cones and beads made from lead or tungsten can be attached, or simply tied on a weighted jig hook to help the fly sink to the desired depth in the water to reach the level fish are holding at.

### BRIEF DESCRIPTION OF THE DRAWINGS

FIG. 1 shows a flow chart of a method in accordance with a first embodiment of the present invention; and

FIG. 2 shows a side view of a fishing fly which simulates the shape of a bait fish.

### DETAILED DESCRIPTION OF THE DRAWINGS

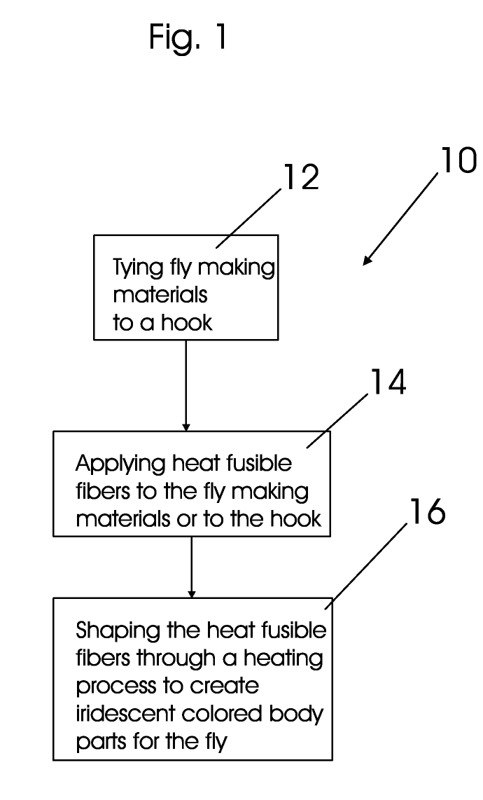

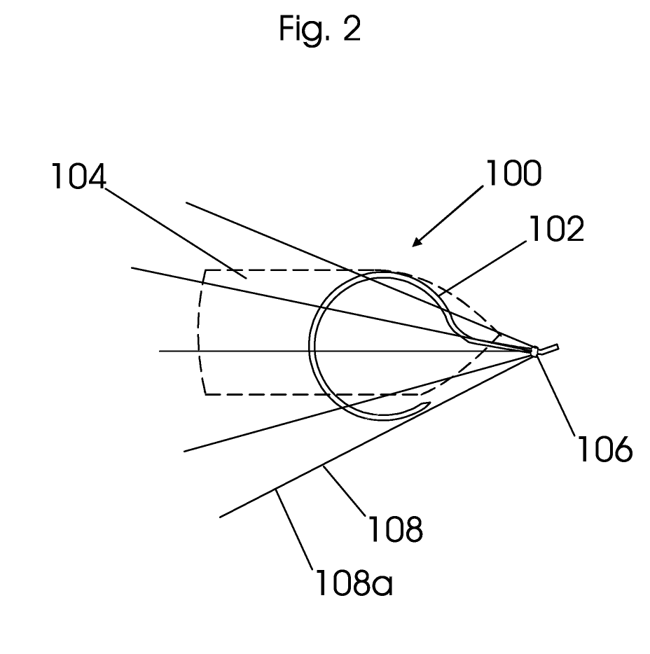

FIG. 1 shows a flow chart 10 of a method in accordance with a first embodiment of the present invention. FIG. 2 shows a side view of a fishing fly 100 which simulates the shape of a bait fish.

At step 12 fly making materials, such as material 108 in FIG. 2, may be tied to a hook, such as hook 102 in FIG. 2, at location 106. At step 14 heat fusible fibers, such as 104 which may be Angelina (trademarked) heat fusible fibers, shown by dashed lines in FIG. 2, may be applied to the fly making material 108 or to the hook 102. At step 16, the heat fusible material 104 is shaped through a heating process to create iridescent colored body parts for the fly 100. The item 104 may be a blend of heat fusible fibers and non-heat fusible polyester fibers.

The fly making material 108 may be in the shape of a bait fish in an orange color preferred by fisherman pursuing spawning steelhead and salmon. The fishing fly 100 may be a thin bodied flat shape which may be created using a heating iron compressing the heat fusible fiber 104 to cause the iridescent colors as well as to seal the heat fusible fiber or material 104 together. Other synthetic fibers not of this material may be added for the purpose of adding another color and texture desired for appearance purposes. The heat fusible fibers can be blended with non-heat fusible polyester fibers.

The heat fusible fibers, such as 104, may be the following colors for example:

Blaze Crystalina

Aurora Crystalina

Blue Magic Crystalina

Violette Crystalina

Mint Sparkle

Pink Tickle

Cobalt Sparkle

Raspberry Sparkle

Lemon Sparkle

Forest Blaze

Peacock

Wisteria

Ultraviolet

Calypso Blue

Key Lime

Watermelon

Sugar Plum

Cotton Candy

Citronella

The above color names are names of the colors that Meadowbrook Inventions, Inc. has given to the various colors of the material they currently manufacture as Heat Fusible fibers.

If non-heat fusible polyester fibers are blended with the heat fusible fibers (i.e. 104 is not only comprised of heat fusible fibers but is a blend), then the non-heat fusible polyester fibers may be the following colors for example:

Holographic Gold

Holographic Silver

Polyester Colors:

Brilliant Chrome Silver

Brilliant Shimmer Sand

Brilliant Sahara

Brilliant Cinnamon

Brilliant Chartreuse

Brilliant Light Gold

Brilliant Rich Red Gold

Brilliant Dark Gold

Brilliant Marigold

Brilliant Penny Copper

Brilliant Golden Orange

Brilliant Apricot

Brilliant Light Copper

Brilliant Pink

Brilliant Light Purple

Brilliant Lilac

Brilliant Perrywinkle

Brilliant Rose Copper

Brilliant Plum

Brilliant Rose

Brilliant Fuchsia

Brilliant Deep Burgundy

Brilliant Fire Red

Brilliant Regal Red

Brilliant Apple Red

Brilliant Garnet

Brilliant Sea Green

Brilliant Ocean Spray

Brilliant Lime

Brilliant Emerald Green

Brilliant Moss Green

Brilliant Midnight Green

Brilliant Ice Blue

Brilliant Sky Blue

Brilliant Blue Teal

Brilliant Stratoshpere

Brilliant Canadian Blue

Brilliant Royal Blue

Brilliant Western Blue

Brilliant Navy

Brilliant Blue Gunmetal

Brilliant Lavender

Brilliant Purple

Brilliant Gunmetal

Brilliant Bronze

Brilliant jet Black

Brilliant White

The same technique may be applied to other types of flies, such as for example a sculpin type baitfish imitation fly. Fins may be made utilizing a hot iron device on a heat fusible fiber to compress and turn iridescent prior to attaching to a hook and then additional colors of the heat fusible fiber may be attached, shaped to form a baitfish body. Tails may be made with a hot iron device to flatten, shape and cause the materials to turn iridescent. Finally a hot air blow gun may be employed to give a rounded shape to the body, help the heat fusible fibers to seal together to improve durability and turn iridescent.

The heat fusible fiber, such as 104, is mixed to achieve the desired color from a selection of colors, and applied to either the hook itself, such as hook 102, or to fly tying materials, such as 108, which are tied or attached to the hook, such as hook 102.

One preferred method of the invention is practiced by tying fly making materials to a conventional fly hook. These materials can include hair, feathers, string, chenille, rubber filaments or tubes, strips of reflective foil, manmade fibers, glitter, or other materials used to make flies. To these materials, colorful heat fusible fiber of the type described above is added to make body parts of the fly. The fly is subjected to a heat treatment step with either an iron, blowing hot air onto the surface or both methods to achieve the desired appearance and function. The heat treatment step adds iridescent qualities and colors and greatly increases the fly's heat fusible fiber's durability in the water. With the heat treatment step, flies of the invention can be fished all day, with the immersion in water that results, with little sign of wear. Some separations of the heat fusible fiber does occur from repeated casting as is practiced in fly fishing, but does not affect the fly to any noticeable degree.

Another embodiment of the present invention provides a method of applying cork or foam, to add buoyancy. Another method of adding buoyancy, in accordance with an embodiment of the present invention, is to add strips of sheet foam. This technique can be applied to nymphs, dries, larvae, insect cases, terrestrials, bass and salt water flies, etc.

Synthetic and natural materials which comprise a tied fly can be shaped or positioned on the fly and held in place, then the heat fusible fiber can be shaped, and secured so that the heat treatment process then can conceal the added materials, such as weighted cones or beads or shaped cork or foam bodies and maintain the intended imitation's appearance. Shapes of body parts such as tails, fins, legs and other imitative shapes can be preformed utilizing the heat fusible fibers, heating to the desired shapes with either a hot iron device such as a hair straightener, household iron with a protective cloth or hot air gun. This could be called heat shaping and attachment. While all tying materials usually require the use of thread to attach to the hook, an epoxy could be utilized. If some of the heat fusible fibers are already attached to the hook, adding the heat fusible fibers or parts made from these can be added with the use of hot melt glue.

Decreasing or increasing the heat treating temperature and/or the duration of heating time may be desirable in developing coloration, shape and texture changes in order to make flies more realistic and/or novel. It is desirable that one start the heating process at lower temperatures and time durations for a particular pattern, as overheating will completely melt the heat fusible fibers and ruin the fly. Additional heat and time applied can be added, if the first application did not achieve the desired effect.

Adding additional synthetics or natural material during the tying process is often very desirable. Materials which are attached to become a part on a fly or the completed fly configuration in the shape of fins, tails, simulated bodies or parts of bodies, which cannot be developed with the heat fusible fibers, can be developed with other materials to achieve the desired effect.

A coat of clear lacquer can be applied to the heat fusible fibers after heat treatment in a final process to add additional stiffness if desired. The lacquer is best applied very lightly by an air brush.

Delineation of body parts during the heat treatment process can be achieved by the use of items such as holding the heat fusible fibers in a certain way with a forceps, temporally wrapping the heat fusible fibers with tying thread or wire ties, and many other inventive ways to achieve any shape the imagination can conceive.

The heat fusible fiber thus eliminates some tying, and results in a unique fly. The heat treatment not only adds durability, but also shrinks the synthetic (plastic) shredded film's treated surface into an iridescent surface.

The heat fusible fiber is shaped on the hook or on the fly materials, according to the particular specifications of the fly pattern being made, according to the anatomical features of the animal being imitated, or according to the desired characteristics of a fanciful fly creation.

The heat fusible fiber can be applied in layers, each layer can be heat treated or not, which creates a multi-layered solid which has the appearance of depth with reflective and refractive properties.

The heat fusible fiber, alone or mixed with other materials, such as cork, foam, plastic, hair, or fur, can be used to create protrusions in the fly body which result in the fly making side to side or oscillatory movements when retrieved. This is easily created immediately after the heat process, before cooled by bending or shaping to get the desired effect when the fly is retrieved through the water.

The heat fusible fiber is compatible with traditional fly tying materials such as hair, feathers and string. It is also compatible with such non-conventional material as tinsel, plastic, rubber and Mylar. By applying the heat fusible fiber to these materials to change their colors, the required inventory of fly tying supplies needs to be much smaller.

The heat fusible fiber can be used as the sole material of which the fly is composed, or it may be used in conjunction with other synthetic and/or natural fly tying materials.

The heat fusible fiber can be used in conjunction with traditional fly tying patterns to augment or modify those patterns. The heat fusible fiber can also be used to create more accurate and non-traditional simulations of naturally occurring insects or other fresh and salt water creatures. The heat fusible fiber can also be used to create fanciful creatures which have colors, shapes and appendages which are not found in nature.

All of the above includes utilizing both the heat fusible fiber and the heating process to achieve any desired effect.

The advantages of the present invention are many fold:

Elimination of some or all of the requirement of tying of materials on to the fly through adding pre-made body parts with hot glue; the heat fusible fiber and the heating process incorporated into the design, providing a method for adding to body parts of the fly; providing a method to quickly and easily add shapes to a fly, providing a method to add iridescent colors to a fly or parts thereof, providing a method of changing the color of flies, and providing a convenient method to add body parts, such as, feet, fins, leg joints, gills, gill plates, scales, egg sacks, spines, quills, plates, antennae and knee joints, but not limited to these specific parts. The light weight of the material, aids in the flotation of dry flies, for a more realistic presentation to the fish, and does not interfere with the casting technique of the user.

While there is shown and described the present preferred embodiment of the invention, it is to be distinctly understood that this invention is not limited thereto but may be variously embodied to practice within the scope of the following claims. Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. A method for constructing a fly for fishing from fly-making materials and a hook which comprises:
tying fly-making materials to a hook;
applying heat fusible fibers to said fly-making materials; and
shaping said heat fusible fibers through a heating process to create iridescent colored body parts of said fly.

2. The method of claim 1 further comprising
blending the heat fusible fibers with non-heat fusible polyester fibers.

3. The method of claim 1 wherein
said heat fusible fibers are shaped through a heating process with a hot iron.

4. The method of claim 1 wherein
said heat fusible fibers are shaped through a heating process with heated air.

5. The method of claim 1 wherein
said heat fusible fibers are shaped through a heating process at temperatures ranging from one hundred and forty to two hundred degrees Fahrenheit for two to ten seconds.

6. A method for constructing a fly for fishing from fly-making materials and a hook which comprises:
tying fly-making materials to a hook;
applying heat fusible fibers to said hook; and
shaping said heat fusible fibers through a heating process to create iridescent colored body parts of said fly.

7. The method of claim 6 wherein
said heat fusible fibers are blended with non-heat fusible polyester fibers.

8. The method of claim 6 wherein
said heat fusible fibers are shaped through a heating process with a hot iron.

9. The method of claim 6 wherein
said heat fusible fibers are shaped through a heating process with heated air.

10. The method of claim 6 wherein
said heat fusible fibers are shaped through a heating process at temperatures ranging from one hundred and forty to two hundred degrees Fahrenheit for two to ten seconds.

11. A fly fishing lure comprising:
a hook;
a tying thread; and
and fly body parts on said hook;
wherein said fly body parts are made of heat fusible fibers;
wherein the heat fusible fibers turn iridescent when heat is applied.

12. The fly fishing lure of claim 11 further comprising
a further fly making material.

13. The fly fishing lure of claim 11 wherein
the further fly making material is a weight.

14. The fly fishing lure of claim 11 wherein
the further fly making material is a floatable material.
